(19) United States
(12) Patent Application Publication
(10) Pub. No.: US 2005/0010503 A1
(43) Pub. Date: Jan. 13, 2005

(54) Operation of market for used motor vehicles

(76) Inventor: Chand Ratnayake, Whitby (CA)

Correspondence Address: BIRCH STEWART KOLASCH & BIRCH, PO BOX 747, FALLS CHURCH, VA, 22040-0747, US

(21) Appl. No.: 10/675,954

(22) Filed: Oct. 2, 2003

(30) Foreign Application Priority Data
Jul. 9, 2003 (CA) 2,434,820

(51) Int. Cl. G06F 17/60

(52) U.S. Cl. 705/34; 705/39

(57) ABSTRACT

An indoor or outdoor market is provided for used motor vehicles that are for sale or lease. Sellers or lessors display their vehicles at the market and potential buyers or lessees are invited to view the vehicles there. The operator of the market provides a number of facilities there to assist the parties. There is a facility where a vehicle can be test driven and there is a facility where a buyer or lessee can search the ownership of a vehicle and determine whether there are any liens registered against it. The latter facility may be a terminal linked to a storage device containing such information. There is an outlet where the parties can transfer ownership of a vehicle and where the buyer or lessee can obtain a licence to operate it. There is also a mechanic who can inspect a vehicle and advise a buyer or lessees on its mechanical fitness and whether it complies with the exhaust emission standards of the jurisdiction where the market is located. There is an insurance agent who can arrange for insurance to cover the vehicle and there is a representative of a financial institution where a buyer or lessee can arrange a loan to pay for the vehicle.

### FIELD OF THE INVENTION

This invention relates to a scheme for facilitating a transaction relating to a used motor vehicle and more particularly to a scheme for facilitating the purchase and leasing of such a vehicle.

### BACKGROUND OF THE INVENTION

A used motor vehicle is sold or leased in a number of different ways. Sometimes it is sold “publicly” by being displayed on a lot with other used vehicles and a potential customer is invited to inspect the vehicle and to negotiate the terms of purchase or lease with a salesperson at the lot. Other times a used vehicle is sold “privately” by being advertised in a newspaper or magazine and the potential buyer is invited to arrange an appointment with the seller so that the buyer can inspect the vehicle and, if he wishes, to negotiate the terms of purchase. Rarely is a vehicle leased by the latter method unless the vehicle is already under lease and the lessor is prepared to negotiate the terms under which a potential lessee will assume the lease.

There is significantly more risk in purchasing or leasing a used motor vehicle than in the purchasing or leasing a new vehicle. This is particularly so where the vehicle is sold or leased privately. For example, the title of a used motor vehicle may be encumbered by a lien. Usually any liens affecting a new vehicle are discharged when the vehicle is sold in the normal course of trade but this is not the case where the vehicle is used. A buyer of a used vehicle may not be aware of this or the buyer may be lulled into a false sense of security by a dishonest seller who tells him that there are no outstanding liens when in fact there are. Even if the buyer or lessee knows that the vehicle may be subject to a lien, it is usually not convenient for him to check to see if in fact there is before the deal is made.

Another risk that a buyer or lessee faces when he is buying or leasing privately is that the vehicle may be mechanically unfit. Unless the buyer or lessee has access to an experienced mechanic, the deal may close without an effective inspection of the vehicle. Even if the seller warrants that the vehicle is fit, the buyer or lessee may not be able to locate the seller in order to enforce his rights against him in the event that the vehicle is in fact unfit.

The buyer or lessee who buys a used vehicle publicly faces fewer risks if the seller is reputable but if the seller is not, the risks are the same as if the sale or lease had occurred privately. For example, if the seller is not reputable the vehicle may not be free of liens when the buyer or lessee takes possession of the vehicle. As for the mechanical fitness of the vehicle, it too may be suspect if the seller is not reputable. Even if the seller is reputable however the buyer or lessee may not have an opportunity to have the vehicle inspected by an experienced mechanic before the deal closes. In addition, the buyer or lessee may not have an opportunity to have the contract of purchase or lease reviewed by a person with knowledge of such contracts to ensure that the contract does not exempt the seller or lessor from liability for mechanical unfitness.

Whether the sale or lease is public or private, the buyer or lessee faces a number of inconveniences that he generally does not have when the vehicle is new. For example, the buyer or lessee usually does not have immediate access to all of the fiends needed to purchase or lease the vehicle. More usually, the buyer must borrow some or all of the funds and he must, as a result, make any offer to the seller contingent upon his being able to borrow those funds. As well, the buyer or lessee will have to ensure that he can arrange the necessary insurance and that too can usually not be arranged until after the vehicle has been purchased or leased. In addition, ownership of the vehicle must be transferred to a buyer before the seller is relieved of responsibility for any accidents that the buyer may cause.

A buyer or lessee of a new vehicle does not usually experience such inconveniences. The seller usually can arrange financing and insurance for the buyer or lessee at the time of purchase or lease and he can usually arrange for transfer of ownership at the same time.

### SUMMARY OF THE INVENTION

I have devised a scheme for selling or leasing used vehicles which eliminates or substantially reduces the risks and inconveniences discussed above. The scheme involves providing a market where sellers or lessors are invited to display their vehicles. The market may be an open space such as a lot or it may be a covered building. At the market there is a mechanic who can inspect a vehicle for mechanical fitness. There is also a representative of a lending institution such as a bank or credit union who can arrange the financial aspects of a purchase or a lease. In addition there is an insurance agent who can arrange insurance to cover a vehicle. Potential buyers or lessees can have a vehicle inspected for mechanical fitness before making an offer to purchase or lease and such persons can also arrange financing and insurance before the offer is made.

As for matters relating to the title, where there is provision for searches through a telephone line or through the Internet, a terminal is provided at the market for such searches. Where searches are available by other means, whatever is needed to make it possible to conduct such searches is provided at the market. Thus inquiries by a potential buyer or lessee for information pertaining to the ownership of and any liens registered against a vehicle may be made by a potential buyer or lessee. There is also provision at the market for the buyer or lessee to obtain a licence plate for the selected vehicle where that is legally possible.

The scheme of my invention has many advantages to the potential buyer, chief of which is that the pitfalls of buying privately are largely eliminated. The buyer can confirm that the seller is the owner of the vehicle and he can, if the circumstances permit, verify that the vehicle is free of liens. As well the buyer can verify that the vehicle is mechanically fit and roadworthy.

The scheme of my invention also has the advantage to the buyer of providing him with the opportunity of arranging financing and insurance at the appropriate time i.e when he is negotiating with the seller over the terms of purchase.

Another advantage to the buyer is that everything that is possible to provide at one place for the purchase is available at the market. The buyer need not go elsewhere such as a garage to have the vehicle inspected and a bank or credit union to arrange financing. The buyer may also attend to other matters at the market. It follows, and as a further advantage to the buyer, that the buyer can conveniently look at a number of vehicles in a relatively short space of time before making a choice. This is to be contrasted with the conventional method for buying a used vehicle privately where a buyer must expend a considerable amount of time travelling to each vehicle that is for sale so that he can inspect it. Sellers of the vehicles are usually not prepared to wait for the buyer to inspect a number of vehicles before making a decision and, as a result, when the buyer decides after inspecting all the vehicles which one he wants, he may find that it has already been sold.

The scheme of my invention also has many advantages to a seller. The seller can display the vehicle at the market at a time that is convenient to him and not at the buyer's convenience. This is to be contrasted with the usual situation where the seller must accommodate the buyer's wishes as far as the time of inspection is concerned. Another advantage of my scheme to the seller is that he is in a position to encourage bidding on the vehicle. There may, for example, be two or more potential buyers present at the same time and the seller can encourage them to bid against each other. If the seller is selling by conventional means, however, he will rarely encounter two buyers at the same time so that bidding is unlikely to occur.

A further advantage to the seller is that he does not have to pay a commission on the sale nor does he lose the dealer's markup on the selling price. If for example he sells the vehicle to a used car dealer, the price he would receive would be approximately the fair market value of the vehicle less the dealer's markup. By contrast if he sells the vehicle by means of my scheme, the seller would not be affected by the dealer's markup and he could expect to receive a higher price.

The operator of the market can make a profit from the operation of my scheme in a number of different ways. The operator can charge seller a fee for the space that a vehicle occupies at the market. Alternatively, the operator can charge the buyer an entrance fee or he can charge the buyer a fee on each sale. In the latter event, the fee can be a fixed amount or it can be a percentage of the selling price.

### DESCRIPTION OF THE DRAWINGS

The scheme of my invention is described in detail with reference to the accompanying drawings, in which:

FIG. 1 sets out schematically the various services that are essential or useful to anyone who wishes to purchase a used motor vehicle; and

FIG. 2 sets out schematically the various services that are essential or useful to anyone who wishes to lease a used motor vehicle.

Like reference characters refer to like services in the scheme described in the drawings.

### DETAILED DESCRIPTION OF THE DRAWINGS

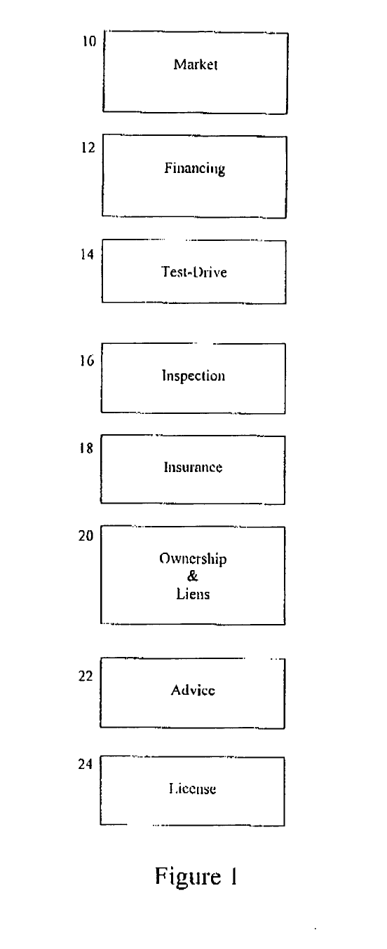

With reference to FIG. 1, the number 10 indicates the underlying service of the provision of a market where sellers are invited to display their used motor vehicles that are for sale. Space in the market can be divided into a number of separate areas and each area can be allocated to vehicles having common characteristics. For example one area can be set aside for vehicles having an asking price of under $10,000, a second area for vehicles having an asking price of between $10,000 and $20,000 and so on. Alternatively, areas can be allocated according to the ages of the vehicles. There may be an area for antique vehicles, another for vehicles of over 10 years in age, a third area to vehicles of between 5 and 10 years old and so on.

By the words “motor vehicle” I refer to all motorized vehicles including cars, sport utility vehicles, trucks, motorcycles, motorized recreational vehicles, mopeds, and so on.

It is not, of course, necessary that the market be divided into separate areas. The vehicles can be spread throughout the market randomly. Where there are relatively few vehicles it may be desirable not to segregate them so that no areas in the market are empty. An empty area may give a prospective buyer the impression that there is a poor selection of vehicles.

The number 12 identifies the service pertaining to financing. A potential buyer may need to borrow some or all of the purchase price of a vehicle and the buyer may arrange a loan for that purpose at the market. To that end, there may be a representative of a lending institution such as a bank or credit union at the market or there may be a terminal at the market where a buyer can arrange a loan electronically without human intervention.

The number 14 identifies space at the market or adjacent to it at which the buyer can test drive a selected vehicle. It is of course essential that such space be provided since few buyers will be prepared to rely solely on a visual inspection of a vehicle, Most buyers will demand space for a test drive before seriously considering purchasing a vehicle.

The number 16 identifies the service of a mechanic who is able to inspect a vehicle and advise on its mechanical fitness and roadworthiness. The mechanic can also, if authorized by law, carry out an exhaust emission test and any other tests that are required by law in the jurisdiction in which the market is located.

The mechanic should be independent of both the buyer and seller so that his inspection will be unbiased and trustworthy. The mechanic should also be required to agree that he will do no work on a vehicle that he has inspected so that there will be no incentive for him to misrepresent the true condition of the vehicle. Preferably, to ensure that the mechanic is independent of both the buyer and seller, he should be paid by the operator of the market. In that way he will be free from interference by both parties to the sale and will not be concerned about whether he will be paid or not according to the report he gives following an inspection or a test.

The number 18 identifies the service pertaining to insurance. A prospective buyer will have to insure the vehicle at the time he takes ownership of it and he may obtain a binder or policy of insurance at the market. There may be an insurance agent or broker at the market or there may be a terminal at the market where a buyer can arrange insurance electronically without human intervention.

The number 20 represents a terminal at the market for receiving inquiries by a buyer for information pertaining to the ownership of a vehicle. That terminal will also provide the buyer with information about any liens against the selected vehicle. The terminal has a processor adapted to create a link between the terminal and a storage device containing such information.

The number 20 also represents the means by a search is carried out where searches are conducted by other means. Whatever is needed to make it possible to conduct such searches is provided at the market.

The number 22 represents the service of an adviser, such as a lawyer, who is familiar with the law pertaining to the buying and selling of used motor vehicles in the jurisdiction in which the market is located. The adviser can explain such things as the manner in which title is transferred, how a buyer can check for liens, the legal ramifications of a warranty that a seller is prepared to give, what kind of insurance should be purchased, how the transaction can be financed and so on. The adviser can also prepare a bill of sale should that be required and assist in completing the forms that are required by law to complete the transaction in the state where the market is located.

The number 24 represents the service pertaining to the issue of a licence plate for the vehicle. In jurisdictions where licence plates are issued manually, there will be a representative of the authority that does so, so that the buyer will be able to drive the vehicle off the market after he has purchased it. In jurisdictions where a sticker is attached to a plate to indicate that the vehicle is licenced, a terminal for applying for a sticker is located at the market. The terminal has a processor adapted to create a link between the terminal and the authority that authorizes the issue of stickers so that the sticker will be issued at the market.

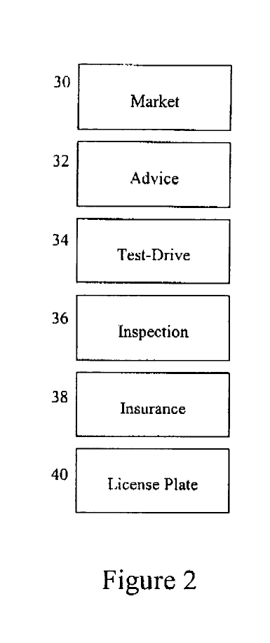

With reference to FIG. 2, the number 30 indicates the provision of a market where lessors are invited to display leased motor vehicles that they wish to dispose of by the assumption of the lease by a third party or “lessee”. Like the market described with reference to FIG. 1, space in the market can be divided into a number of separate areas and one or more of those areas can be set aside for leased vehicles. Those areas can be allocated to leased vehicles having common characteristics such as those where the lease payments are under $500.00 per month, those between $500.00 and $1,000.00 and so on.

The number 32 represents the service of an adviser with knowledge of leases, such as a lawyer, to review with a prospective lessee the terms of the lease which covers the vehicle of interest to the lessee. That adviser will be there to inform the lessee on who is responsible for such things as insurance, maintenance and repairs and what the lessee's payments will be during the term of the lease. The adviser will also be there to inform the lessee on when the lease expires and what the lessee's rights are at that time should he wish to purchase the vehicle. The adviser will also inform the lessee on how to have the lessor's name removed from the lease and how the lessee's name can be substituted for it.

The number 34 covers a test-drive since a lessee will want to test-drive a vehicle. Number 36 covers a mechanical inspection and 38 covers insurance which the lessee may require unless the owner of the vehicle is responsible for that.

The lessee will be unlikely to need to know who the vehicle belongs to or whether there are liens against it since prior lessees will not be shown as owners. Prior lessees are generally not able to pledge the vehicle as security for a loan so that a search for liens is unlikely to be required. The adviser at step 32 will be able to let the lessee know if this is not the case.

The lessee will require a licence plate and number 40 indicates that service.

It will be understood of course that modifications can be made in the scheme of the invention without departing from the scope and purview of the scheme as defined in the claims that follow.

1. A scheme for facilitating a transaction involving a used motor vehicle including: providing a market in which a plurality of used motor vehicles are adapted to be displayed to a potential buyer; providing the resources associated with the market for the buyer to test-drive a selected vehicle; providing the resources associated with the market for the buyer to have the selected vehicle inspected for mechanical fitness, providing the means associated with the market for the buyer to obtain information pertaining to the ownership of and any liens against the selected vehicle; and providing the resources associated with the market for the buyer to obtain a licence for the selected vehicle in the jurisdiction in which the market is located.

2. The scheme of claim 1 further including: providing the resources associated with the market for the buyer to arrange the financial aspects of the transaction; and providing the resources associated with the market for the buyer to arrange insurance to cover the selected vehicle.

3. The scheme of claim 2 further including: providing the resources associated with the market for the buyer to obtain legal advice concerning the transaction.

4. The scheme as claimed in claim 1 further including providing the resources at the market for the buyer to arrange a loan to cover the whole or part of the purchase price of the selected vehicle.

5. The scheme as claimed in claim 1 further including: providing the resources at the market for the buyer to arrange insurance to cover the selected vehicle.

6. The scheme of claim 1 further including: providing the resources associated with the market for the buyer to obtain information pertinent to the legal requirements for obtaining a licence to operate the motor vehicle.

7. The scheme of claim 1 wherein said means for obtaining information pertaining to the ownership of and any liens against the selected vehicle includes a terminal having a processor adapted to create a link between the terminal and a storage device containing information pertaining to the ownership of and any liens against the selected vehicle.

8. The scheme of claim 1 wherein the resources associated with the market for the buyer to have the selected vehicle inspected for mechanical fitness include a mechanic who receives no payment from the buyer and from a seller of the selected vehicle for carrying out the inspection.

9. The scheme of claim 8 including requiring the mechanic to do no work on the selected vehicle following the inspection.

10. The scheme of claim 8 wherein said mechanic is paid by an operator of the market for carrying out the inspection.

11. A scheme for facilitating the arranging of a lease involving a used motor vehicle including: providing a market in which a plurality of used motor vehicles are adapted to be displayed to a potential lessee; providing the resources at the market for the lessee to test-drive a selected vehicle; providing the resources at the market for the lessee to have the selected vehicle inspected for mechanical fitness; providing the resources at the market for the lessee to obtain an explanation of the contents of a lease under which the lessee would have the use of the selected vehicle for a specified time; and providing the resources at the market for the lessee to obtain a licence plate for the selected vehicle.

12. The scheme as claimed in claim 11 further including: providing the resources at the market for the lessee to arrange insurance to cover the selected vehicle.

13. The scheme as claimed in claim 11 further including: providing a terminal at the market for receiving inquiries by a lessee for information pertaining to the ownership of and any liens against the selected vehicle and for displaying responses thereto, the terminal having a processor adapted to create a link between the terminal and a storage device containing said information.

14. The scheme as claimed in claim 1 further including: charging a fee for space occupied by a motor vehicle at said market.

15. The scheme as claimed in claim 1 further including: charging a fee for admission to said market.

16. The scheme as claimed in claim 1 further including: charging a fee on each transaction involving a motor vehicle.

17. The scheme as claimed in claim 1 further including providing the resources associated with the market to carry out an exhaust emission test on the selectee vehicle.
